(19) United States
(12) Patent Application Publication
(10) Pub. No.: US 2012/0093261 A1
(43) Pub. Date: Apr. 19, 2012

(54) METHOD AND APPARATUS OF TRANSMITTING DOWNLINK CONTROL SIGNAL IN WIRELESS COMMUNICATION SYSTEM

(75) Inventors: Jun Woo Kim, Daejeon-si (KR); Jung Pil Choi, Daejeon-si (KR); Hyeong Sook Park, Daejeon-si (KR); Eon Young Hong, Daejeon-si (KR); Youn Ok Park, Daejeon-si (KR)

(73) Assignee: ELECTRONICS AND TELECOMMUNICATIONS RESEARCH INSTITUTE, Daejeon (KR)

(21) Appl. No.: 13/273,423

(22) Filed: Oct. 14, 2011

(30) Foreign Application Priority Data
Oct. 18, 2010 (KR) 10-2010-0101531
Mar. 17, 2011 (KR) 10-2011-0023674

(51) Int. Cl. H04L 27/06; H04L 27/00

(52) U.S. Cl. 375/299; 375/340

(57) ABSTRACT

Disclosed herein are a method and an apparatus for transmitting a downlink control signal in a wireless communication system. The apparatus for transmitting a downlink control signal includes: a preamble symbol generator generating preamble orthogonal frequency division multiplexing (OFDM) symbols based on a first pilot pattern among pilot patterns for each of the plurality of transmit antennas; a midamble symbol generator generating midamble OFDM symbols based a second pilot pattern excluding the first pilot pattern from the pilot patterns for each of the plurality of transmit antennas; an IFFT unit performing inverse fast Fourier transform (IFFT) for each transmit antenna on the preamble OFDM symbol and the midamble OFDM symbol; and a plurality of transmit antennas transmitting the preamble OFDM symbols and the midamble OFDM symbols.

### CROSS-REFERENCE TO RELATED APPLICATIONS

This application claims the benefit of priority of Korean Patent application No. 10-2010-0101531 filed on Oct. 18, 2010, and Korean Patent application No. 10-2011-0023674 filed on Mar. 17, 2011, all of which are incorporated by reference in their entirety herein.

### BACKGROUND OF THE INVENTION

1. Field of the Invention

The present invention relates to wireless communication, and more particularly, to a method and an apparatus of transmitting a downlink control signal in a wireless communication system.

2. Related Art

In the case of a broadband wireless communication system, efficient transmit and receive methods and methods using the same have been proposed so as to maximize efficiency of limited wireless resources. One of the systems that have been considered in a next-generation wireless communication system is an orthogonal frequency division multiplexing (OFDM) system capable of offsetting inter-symbol interference (ISI) effects with low complexity. The OFDM converts data symbols input in series into N parallel data symbols and then, transmits the converted data symbols by carrying the converted data symbols on each of the N subcarriers. The subcarriers need to be maintained orthogonality in a frequency domain. Each orthogonal channel experiences frequency selective fading independent from each other, such that complexity at a receive end is reduced and an interval of the transmitted symbols is long, thereby minimizing the inter-symbol interference.

As a technology for supporting reliable and high-speed data services, a multiple input multiple output (MIMO) may be considered. The MIMO technology uses a multiple transmit antenna and a multiple receive antenna to improve the transmit and receive efficiency of data. An example of the MIMO technology may include spatial multiplexing, transmit diversity, beamforming, or the like. A MIMO channel matrix according to the number of receive antennas and the number of transmit antennas may be decomposed into a plurality of independent channels. Each independent channel may be referred to as a layer or a stream. The number of layers is referred to as a rank.

In the OFDM system, a preamble is transmitted for initial timing synchronization, frequency synchronization, and cell search. In addition, in the MIMO OFDM system, a midamble is transmitted so as to measure channel gains between the transmit antennas and the receive antennas. The midamble, which transmits pilot subcarriers through different subcarriers within at least one OFDM symbol, may easily measure the channel gains of the receive antennas through the pilot subcarriers. Generally, the preamble is transmitted so as to only acquire the timing synchronization and the frequency synchronization, search the cells, or the like, and the midamble may be transmitted so as to calculate the channel gains. However, a cooperation type of the preamble and the midamble may be transmitted according to characteristics of the preamble and the midamble, thereby increasing the transmit efficiency.

Therefore, a need exists for a method for effectively transmitting the preamble and the midamble.

### SUMMARY OF THE INVENTION

The present invention provides a method and an apparatus of transmitting a downlink control signal in a wireless communication system.

In an aspect, a transmitter in a wireless communication system is provided. The transmitter includes a preamble symbol generator generating preamble orthogonal frequency division multiplexing (OFDM) symbol based on a first pilot pattern among pilot patterns for each of a plurality of transmit antennas, a midamble symbol generator generating midamble OFDM symbol based a second pilot pattern excluding the first pilot pattern from the pilot patterns for each of the plurality of transmit antennas, an inverse fast Fourier transform (IFFT) unit performing IFFT for each of the plurality of transmit antennas on the preamble OFDM symbol and the midamble OFDM symbol, and the plurality of transmit antennas transmitting the preamble OFDM symbol and the midamble OFDM symbols.

The number of the plurality of transmit antennas may be four.

The first pilot pattern may be a pilot pattern for one of the plurality of transmit antennas.

The pilot subcarrier for the one of the plurality of transmit antennas may be allocated at three subcarrier intervals.

The pilot subcarriers for each of the plurality of transmit antennas in the second pilot pattern may be allocated at three subcarrier intervals.

The first pilot pattern may be pilot patterns for two of the plurality of transmit antennas.

The pilot subcarriers for each of the plurality of transmit antennas in the first pilot pattern and the second pilot pattern may be allocated at four subcarrier intervals.

The first pilot pattern may be repeated in a time domain.

The first pilot pattern may be configured based on different sequences for each cell.

The preamble OFDM symbol and the midamble OFDM symbol may be consecutive to each other.

In another aspect, a receiver in a wireless communication system is provided. The receiver includes a plurality of receive antennas receiving preamble orthogonal frequency division multiplexing (OFDM) symbol and a midamble OFDM symbol, an fast Fourier transform (FFT) unit performing FFT on the preamble OFDM symbol and the midamble OFDM symbol, a preamble acquisition unit acquiring a preamble sequence based on the preamble OFDM symbol, a midamble acquisition unit acquiring a midamble sequence based on the midamble OFDM symbol, and a channel gain calculator obtaining channel gains based on the preamble sequence and the midamble sequence.

The preamble OFDM symbol may include a pilot subcarrier for at least one receive antenna.

The pilot subcarrier for the at least one receive antenna may be allocated at a uniform interval.

The number of the plurality of receive antennas may be four.

The preamble OFDM symbol and the midamble OFDM symbol may be consecutive to each other.

### BRIEF DESCRIPTION OF THE DRAWINGS

FIG. 1 is a diagram showing a wireless communication system.

FIG. 2 is a diagram showing an example of a preamble construction in an IEEE 802.16e system.

FIG. 3 is a diagram showing an example of a midamble construction in an IEEE 802.16e system.

FIG. 4 is an example of preamble-midamble cooperation transmission according to a proposed method of transmitting a downlink control signal.

FIG. 5 is another example of preamble-midamble cooperation transmission according to a proposed method of transmitting a downlink control signal.

FIG. 6 is an exemplary embodiment of a proposed method of transmitting a downlink control signal.

FIG. 7 is an exemplary embodiment of a proposed method of receiving a downlink control signal.

### DESCRIPTION OF EXEMPLARY EMBODIMENTS

Hereinafter, embodiments of the present invention will be described in detail with reference to the accompanying drawings so that those skilled in the art may easily practice the present invention. However, the present invention may be modified in various different ways and is not limited to the embodiments provided in the present description. In the accompanying drawings, portions unrelated to the description will be omitted in order to obviously describe the present invention, and similar reference numerals will be used to describe similar portions throughout the present specification. Further, when a detailed description is omitted, only a detailed description of portions that may be easily understood by those skilled in the art will be omitted.

Through the present specification and claims, unless explicitly described otherwise, “comprising” any components will be understood to imply the inclusion of other components rather than the exclusion of any other components.

Technologies, such as code division multiple access (CDMA), frequency division multiple access (FDMA), time division multiple access (TDMA), orthogonal frequency division multiple access (OFDMA), single carrier frequency division multiple access (SC-FDMA), or the like, may be used for various wireless communication systems. The CDMA may be implemented by radio technologies, such as universal terrestrial radio access (UTRA), CDMA 2000, or the like. The TDMA may be implemented by radio technologies, such as global system for mobile communications (GSM)/general packet radio service (GPRS)/enhanced data for GSM evolution (EDGE), or the like. The OFDMA may be implemented by radio technologies, such as IEEE 802.11 (Wi-Fi), IEEE 802.16 (WiMAX), IEEE 802-20, evolved-UTRA (E-UTRA), or the like. IEEE 802.16m is evolved from IEEE 802.16e and provides backward compatibility with a system based on the IEEE 802.16e. The UTRA is a part of a universal mobile telecommunication system (UMTS). 3rd generation partnership project (3GPP) long term evolution (LTE) is a part of the evolved-UMTS (E-UMTS) using evolved-UMTS terrestrial radio access (E-UTRA) and adopts the OFDMA in a downlink and adopts the SC-FDMA in an uplink. LTE-advanced (LTE-A) is evolved from the 3GPP LTE.

In order to elucidate descriptions, the IEEE 802.16e is mainly described, but a technical idea of the present invention is not limited thereto.

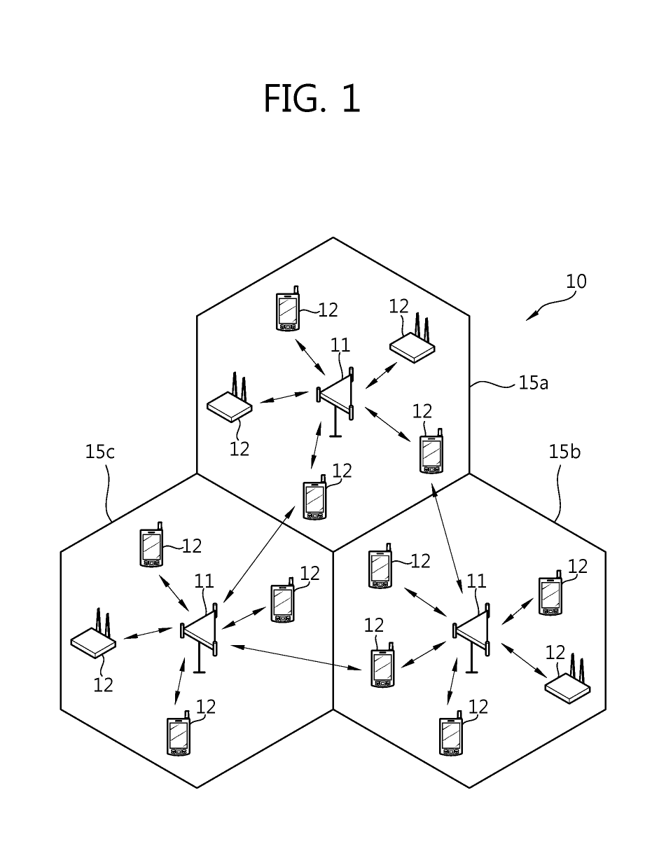

FIG. 1 shows a wireless communication system.

A wireless communication system 10 includes at least one base station (BS) 11. Each base station 11 provides communication services in specific geographical areas (generally referred to as a cell) 15a, 15b, and 15c. The cell may again be divided into a plurality of areas (referred to as a sector). A user equipment (UE) 12 may be fixed or moved and may be referred to as other terms, such as a mobile station (MS), a mobile terminal (MT), a user terminal (UT), a subscriber station (SS), a wireless device, a personal digital assistant (PDA), a wireless modem, a handheld device, or the like. The base station 11 is generally referred to as a fixed station that communicates with the UE 12 and may be referred to as other terms, such as evolved-NodeB (eNB), a base transceiver system (BTS), an access point, or the like.

The UE belongs to a single cell and a cell to which the UE belongs is referred to as a serving cell. The base station providing the communication services to the serving cell is referred to as a serving base station (serving BS). The wireless communication system is a cellular system, such that there are other cells neighboring the serving cell. Other cells neighboring the serving cell are referred to as a neighbor cell. The base station providing the communication services to the neighbor cells is referred to as a neighbor base station (neighbor BS). The serving cell and the neighbor cell are relatively determined based on the UE.

The technology may be used for a downlink or an uplink. Generally, the downlink means communication from the base station 11 to the UE 12 and the uplink means communication from the UE to the base station 11. In the downlink, a transmitter may be a part of the base station 11 and a receiver may be a part of the UE 12. In the uplink, a transmitter may be a part of the UE 12 and a receiver may be a part of the base station 11.

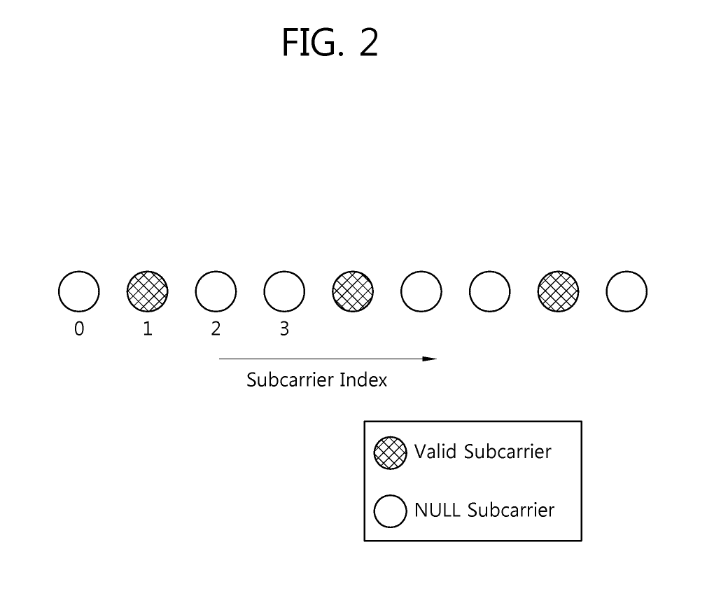

FIG. 2 shows an example of a preamble construction in an IEEE 802.16e system. In a time domain, a preamble may be transmitted through a single OFDM symbol per 5 ms. In this case, a first OFDM system of downlink transmission may be used for the preamble. In a frequency domain, the preamble may be transmitted through a single valid subcarrier per three subcarriers. Referring to FIG. 2, the preamble is transmitted through valid subcarriers of which subcarrier intervals each are 3 and subcarrier indexes are 1, 4, . . . . In the case in which the preamble is transmitted by disposing the valid subcarriers at a predetermined interval in the frequency domain of the OFDM symbol as described above, the preamble repeatedly appears in the same or similar pattern when the preamble is converted into the time domain using inverse fast Fourier transform (IFFT). The preamble may be used so as to acquire time synchronization or frequency synchronization by using the characteristics. Meanwhile, the IEEE 802.16m that is a subsequent standard of the IEEE 802.16e subdivides and transmits the preamble into a primary advanced (PA)-preamble and a secondary advanced (SA)-preamble.

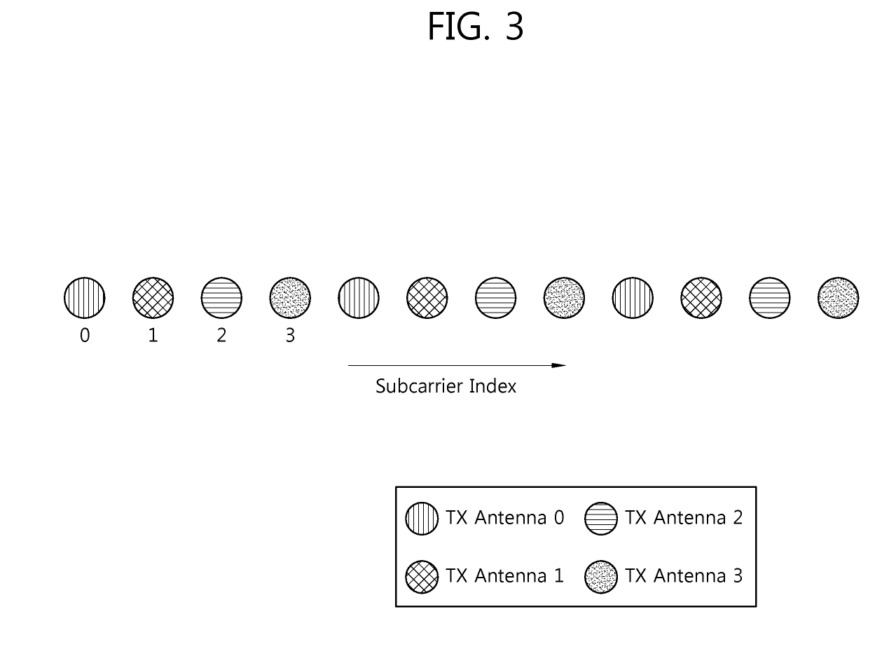

FIG. 3 shows an example of a midamble construction in an IEEE 802.16e system. FIG. 3 is a midamble construction when a transmit antenna is four. Transmit antenna 0 transmits the midamble in subcarrier indexes 0, 4, . . . , transmit antenna 1 transmits the midamble in subcarrier indexes 1, 5, . . . , transmit antenna 2 transmits the midamble in subcarrier indexes 2, 6, . . . , and transmit antenna 3 transmits the midamble in subcarrier indexes 3, 7, . . . , respectively. That is, the subcarriers in which each transmit antenna transmits the midamble does not overlap each other. The receive antenna reads the midamble transmitted by each transmit antenna to measure channel gains between each transmit antenna and each receive antenna. For example, a value reading the subcarrier indexes 0, 4, . . . becomes h₁₁ that is the channel gain between the transmit antenna 0 and the receive antenna and a value reading the subcarrier indexes 1, 5, . . . becomes h₂₂ that is the channel gain between the transmit antenna 1 and the receive antenna.

Generally, the preamble is transmitted so as to only acquire the time synchronization and the frequency synchronization, search the cells, or the like, and the midamble may be transmitted so as to calculate the channel gain. However, in the OFDM symbol transmitting the preamble, the subcarrier within the frequency domain is configured as a pseudo-noise (PN) code that is determined based on a cell identifier (ID) for the cell search. Therefore, in the OFDM symbol transmitting the preamble, the subcarrier within the frequency domain may be used so as to calculate the calculation of the channel gains for each antenna. That is, a part of the information transmitted as the midamble may be transmitted through the preamble.

Hereinafter, a proposed method for transmitting a downlink control signal proposed through the exemplary embodiment of the present invention will be described. The exemplary embodiment of the present invention proposes a method for transmitting a preamble and a midamble in a cooperation type. A part of the information of the midamble is transmitted through the preamble by the exemplary embodiment of the present invention, thereby increasing the transmission efficiency of the midamble.

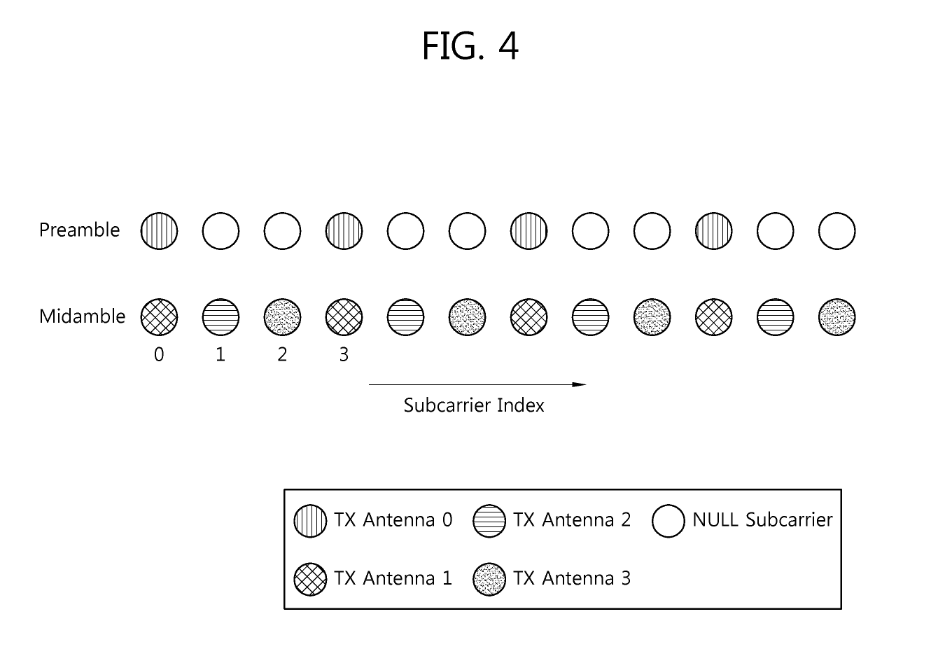

FIG. 4 is an example of proposed preamble-midamble cooperation transmission according to the proposed method of transmitting a downlink control signal.

Referring to FIG. 4, in the MIMO system in which the number of transmit antennas is four, the pilot subcarrier for the single transmit antenna is transmitted through the preamble OFDM symbol, not the midamble OFDM symbol. FIG. 4 shows that the pilot subcarrier for transmit antenna 0 is transmitted through the preamble OFDM symbol, but the exemplary embodiment of the present invention is not limited thereto. The pilot subcarrier for any one of transmit antennas 1 to 3 may be transmitted through the preamble OFDM symbol. In the midamble OFDM symbol, the pilot subcarriers for the remaining transmit antennas are disposed at a predetermined interval and are transmitted.

When comparing the preamble-midamble cooperation transmit method of FIG. 4 with the midamble transmit method of FIG. 3 according to the related art, in FIG. 3, the information transmitted by the single transmit antenna occupies ¼ of the valid subcarrier in the midamble OFDM symbol. On the other hand, in FIG. 4, the information transmitted by the single transmit antenna occupies ⅓ of the valid subcarrier in the midamble OFDM symbol. Generally describing this, when the number of transmit antenna is NT, each transmit antenna may use only 1/NT valid subcarriers in the midamble transmit method according to the related art and each transmit antenna may use only 1/(NT−1) valid subcarriers in the proposed preamble-midamble cooperation transmit method. That is, the channel gains for each transmit antenna may be more accurately calculated.

According to the exemplary embodiment of the present invention, when the information on some of the plurality of transmit antennas is transmitted through the preamble OFDM symbol, the information transmitted through the preamble OFDM symbol may be the overall information to be transmitted to the single transmit antenna and may be configured by a combination of the information to be transmitted to several transmit antennas. However, in order to be transmitted meeting the characteristics of the preamble, the information transmitted through the preamble OFDM symbol needs to have the characteristics repeated in the time domain and needs to be configured using different sequences for each cell ID for the cell search.

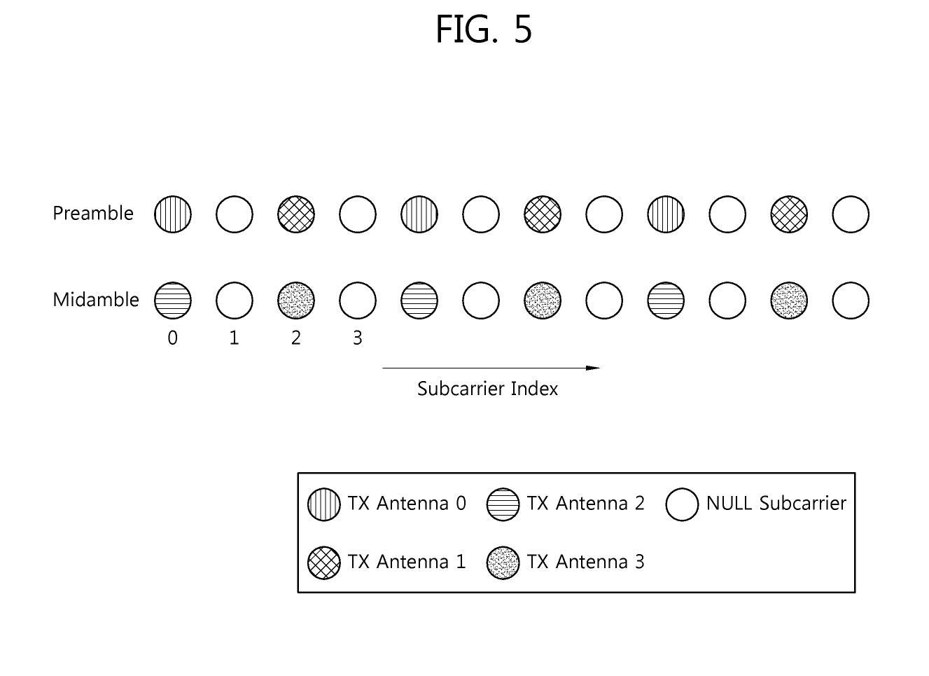

FIG. 5 is another example of preamble-midamble cooperation transmission according to the proposed method of transmitting a downlink control signal.

Referring to FIG. 5, in the MIMO system in which the number of transmit antennas is four, the pilot subcarriers for two transmit antennas are transmitted through the preamble OFDM symbol. FIG. 5 shows that the pilot subcarriers for transmit antennas 0 and 1 are transmitted through the preamble OFDM symbol, but is not limited thereto. In the midamble OFDM symbol, the pilot subcarriers for transmit antennas 2 and 3 that are the remaining transmit antenna are transmitted by being disposed at a predetermined interval.

In the case of the preamble-midamble cooperation transmit method of FIG. 5, the number of valid subcarriers used by each transmit antenna is the same as the number of valid subcarriers used by each transmit antenna in the midamble transmit method according to the related art, such that the channel gain calculation cannot be improved. However, since the preamble-midamble cooperation transmit method is the type in which the preamble and the midamble are repeated just two times in the time domain, the midamble may be used as the usage of the preamble. That is, it is possible to match the time synchronization the frequency synchronization using the midamble. The preamble-midamble cooperation transmit method uses the midamble like the preamble under the environment that the channel gains may be sufficiently and accurately calculated by only the midamble according to the related art, thereby improving the initial synchronization acquisition performance.

According to the exemplary embodiment of the present invention, when the information on some of the plurality of transmit antennas is transmitted through the preamble OFDM symbol, the information transmitted through the preamble OFDM symbol may be the overall information to be transmitted to the single transmit antenna and may be configured by a combination of the information to be transmitted to several transmit antennas. However, in order to be transmitted meeting the characteristics of the preamble, the information transmitted through the preamble OFDM symbol needs to have the characteristics repeated in the time domain and needs to be configured using different sequences for each cell ID for the cell search.

Meanwhile, in the case of the proposed preamble-midamble cooperation transmission, the preamble OFDM symbol and the midamble OFDM symbol are disposed so as to approximate each other as maximally as possible.

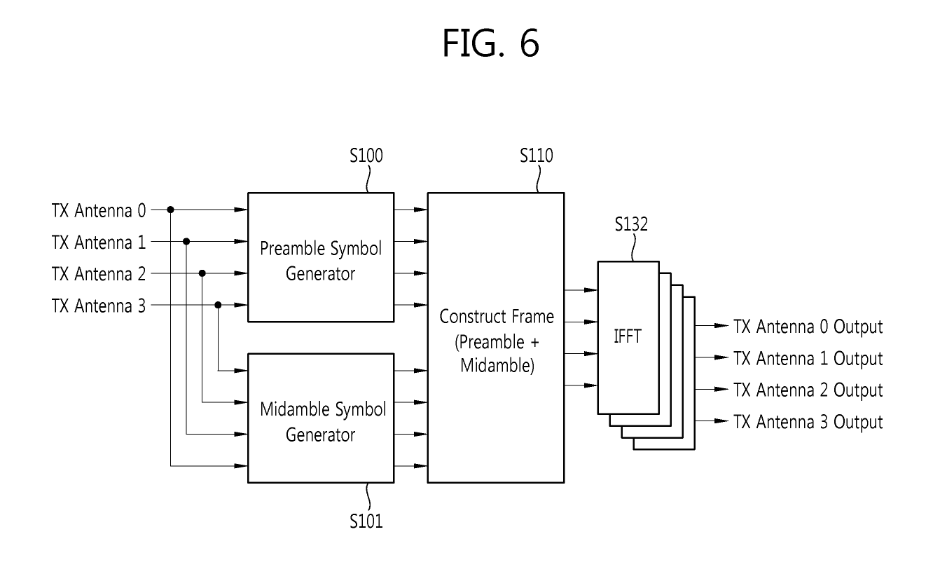

FIG. 6 shows an exemplary embodiment of the proposed method of transmitting a downlink control signal.

Referring to FIG. 6, at S100, the transmitter generates the preamble symbol based on the pilot patterns for some transmit antennas among the pilot patterns for each of the plurality of transmit antennas. At S101, the transmitter generates the midamble symbols based on the pilot patterns not generated by the preamble symbols among the pilot patterns for each of the plurality of antennas. At S110, the transmitter configures the frame including the generated preamble symbols and midamble symbols. At S120, the transmitter performs the IFFTs for each transmit antenna on the preamble symbols and the midamble symbols included in the frame and transmits the preamble symbols and the midamble symbols.

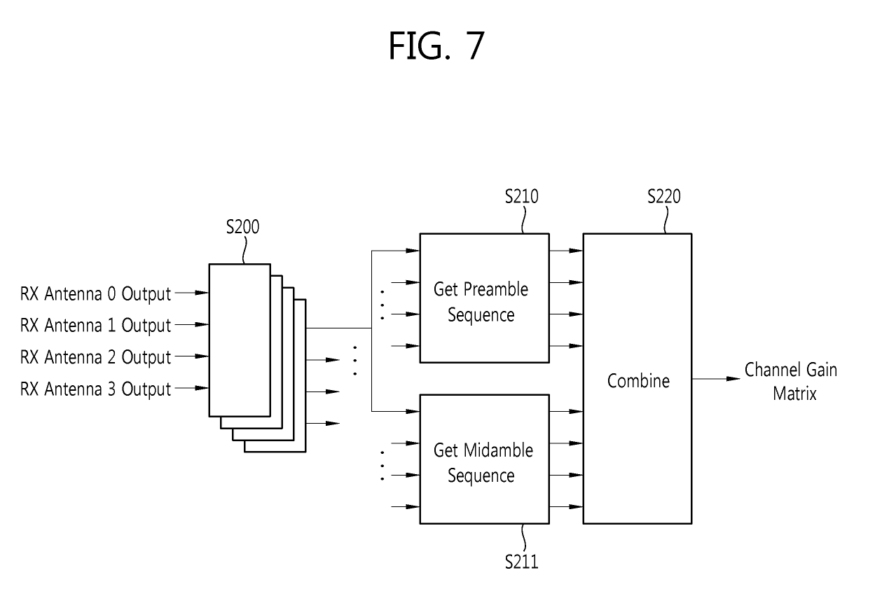

FIG. 7 shows an exemplary embodiment of the proposed method of receiving a downlink control signal.

Referring to FIG. 7, at S200, the receiver performs the FFT on the preamble and the midamble that are received through a plurality of receive antennas. At S210, the receiver acquires the preamble sequence and at S211, the receiver acquires the midamble sequence. At S220, the receiver calculates the channel gain matrix by combining the acquired preamble sequence and midamble sequence.

The exemplary embodiments of the present invention may be implemented by hardware, software, or a combination thereof. The hardware may be implemented by an application specific integrated circuit (ASIC), digital signal processing (DSP), a programmable logic device (PLD), a field programmable gate array (FPGA), a processor, a controller, a microprocessor, other electronic units, or a combination thereof, all of which are designed so as to perform the above-mentioned functions. The software may be implemented by a module performing the above-mentioned functions. The software may be stored in a memory unit and may be executed by a processor. The memory unit or a processor may adopt various units well-known to those skilled in the art.

As set forth above, the exemplary embodiments of the present invention can more accurately calculate the channel gains by cooperatively transmitting the preamble and the midamble. Further, the exemplary embodiments of the present invention can improve the initial synchronization acquisition performance.

In the above-mentioned exemplary system, although the methods have described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A transmitter in a wireless communication system, comprising:
a preamble symbol generator generating preamble orthogonal frequency division multiplexing (OFDM) symbol based on a first pilot pattern among pilot patterns for each of a plurality of transmit antennas;
a midamble symbol generator generating midamble OFDM symbol based a second pilot pattern excluding the first pilot pattern from the pilot patterns for each of the plurality of transmit antennas;
an inverse fast Fourier transform (IFFT) unit performing IFFT for each of the plurality of transmit antennas on the preamble OFDM symbol and the midamble OFDM symbol; and
the plurality of transmit antennas transmitting the preamble OFDM symbol and the midamble OFDM symbols.

2. The transmitter of claim 1, wherein the number of the plurality of transmit antennas is four.

3. The transmitter of claim 1, wherein the first pilot pattern is a pilot pattern for one of the plurality of transmit antennas.

4. The transmitter of claim 3, wherein the pilot subcarrier for the one of the plurality of transmit antennas is allocated at three subcarrier intervals.

5. The transmitter of claim 3, wherein the pilot subcarriers for each of the plurality of transmit antennas in the second pilot pattern is allocated at three subcarrier intervals.

6. The transmitter of claim 1, wherein the first pilot pattern is pilot patterns for two of the plurality of transmit antennas.

7. The transmitter of claim 6, wherein the pilot subcarriers for each of the plurality of transmit antennas in the first pilot pattern and the second pilot pattern are allocated at four subcarrier intervals.

8. The transmitter of claim 1, wherein the first pilot pattern is repeated in a time domain.

9. The transmitter of claim 1, wherein the first pilot pattern is configured based on different sequences for each cell.

10. The transmitter of claim 1, wherein the preamble OFDM symbol and the midamble OFDM symbol are consecutive to each other.

11. A receiver in a wireless communication system, comprising:
a plurality of receive antennas receiving preamble orthogonal frequency division multiplexing (OFDM) symbol and a midamble OFDM symbol;
an fast Fourier transform (FFT) unit performing FFT on the preamble OFDM symbol and the midamble OFDM symbol;
a preamble acquisition unit acquiring a preamble sequence based on the preamble OFDM symbol;
a midamble acquisition unit acquiring a midamble sequence based on the midamble OFDM symbol; and
a channel gain calculator obtaining channel gains based on the preamble sequence and the midamble sequence.

12. The receiver of claim 11, wherein the preamble OFDM symbol includes a pilot subcarrier for at least one receive antenna.

13. The receiver of claim 12, wherein the pilot subcarrier for the at least one receive antenna is allocated at a uniform interval.

14. The receiver of claim 11, wherein the number of the plurality of receive antennas is four.

15. The receiver of claim 11, wherein the preamble OFDM symbol and the midamble OFDM symbol are consecutive to each other.
